(19) United States
(12) Patent Application Publication
(10) Pub. No.: US 2014/0278807 A1
(43) Pub. Date: Sep. 18, 2014

(54) CLOUD SERVICE OPTIMIZATION FOR COST, PERFORMANCE AND CONFIGURATION

(71) Applicant: CLOUDAMIZE, INC., Philadelphia, PA (US)

(72) Inventor: Khushboo Bohacek, Philadelphia, PA (US)

(73) Assignee: CLOUDAMIZE, INC., Philadelphia, PA (US)

(21) Appl. No.: 14/214,042

(22) Filed: Mar. 14, 2014

Related U.S. Application Data
(60) Provisional application No. 61/793,299, filed on Mar. 15, 2013.

(51) Int. Cl. G06Q 30/02

(52) U.S. Cl. CPC G06Q 30/0206
USPC 705/7.35

(57) ABSTRACT

Described embodiments provide for a cloud computing system with cloud services provided by several cloud service providers. Cloud service data is collected from sensors within each cloud service provider's service, and system models are developed based on the collected cloud service data. The user provides configuration data that is related to performance and cost objectives for the cloud computing system. Performance and cost predictions for the cloud computing system are generated based on the system models and the user configuration data; and then processed to provide a set of attributes and parameters for the cloud computing system. The set of attributes and parameters for the cloud computing system are presented to the user for selection. Based on the set of attributes and parameters, the cloud computing system operates by employing selected attributes and parameters from within a set of differing cloud service providers.

### CROSS-REFERENCE TO RELATED APPLICATIONS

This application claims the benefit of the filing date of U.S. provisional patent application No. 61/793,299 filed Mar. 15, 2013, the teachings of which are incorporated herein in their entireties by reference.

### BACKGROUND

“Cloud-based services” refers to the delivery of computing resources, data storage and other information technology (IT) services via a network infrastructure, such as the Internet. Data centers and servers of the “cloud” (e.g., a network) might provide the computing resources, data storage, and IT services. Cloud computing services provided by a cloud-computing provider can have significant benefits over more traditional computing such housing fixed computing infrastructure in a datacenter. One benefit of cloud computing is that a user might achieve lower cost running their computing infrastructure in the cloud as compare to other alternatives. Cloud service providers (CSPs) may offer a wide range of specific computing services and, because of economies of scale and other factors, these services can be offered at low cost. Besides economy of scale, the cloud services can be provided at low cost because a service can be shared among many cloud users. For example, a user can purchase a cloud-based virtual machine for a few hours. When this machine is running, it will utilize some of the CSP's limited resources. Once the user is done using the virtual machine, the CSP can allow another user to purchase use of the resources required to run a virtual machine. As a result, while two users are running virtual machines, the CSP can support this use with the resources to support only one virtual machine. This allows the CSP to offer the purchase of the virtual machine at a lower cost than the users would need to pay to have dedicated resources for the virtual machine. To put it another way, CSPs allow users to share computing resources with other users. This sharing allows the CSP to offer the computing resources at a lower cost than the cost of comparable dedicated computing resources.

This sharing of computing resources is a new paradigm for enterprise computing and poses challenges for both the CSP and the consumer of the CSP services. On the one hand, the CSP desires to package services in a way that maximized sharing and the financial benefit that the CSP receives from its users. On the other hand, the consumers desire to use the CSP services in a way to maximize their specific goals. In order for the CSP to meet their goals, they offer a limited range of services and provide a range of contracts to purchase the use of the services. As an example, Amazon.com, Inc. (“Amazon”) allows users to purchase the use of virtual machines. Amazon allows the virtual machines to with different types of computational abilities., and currently offers 29 types of computational abilities. Because geographic location of the resources can impact the utility of the computational resources (e.g., there are performance benefits of having web servers geographically close the users of the web server), Amazon offers these resources at 21 locations. Hence, the purchase of a single computational resource requires making a selection of one out of 609. Moreover, Amazon allows the virtual machines to take advantage of different performance levels of disk IO and network IO. Each combination of computing, disk IO, and network IO can be purchased at a different price. Moreover, different types of contracts might be used to purchase resources. For example, a purchase of computing resources via a contract allows different amounts of upfront payment and reduced incremental payment over a particular commitment period. Amazon also provides a market where a user that has purchased contracts can also resell the contracts to other users. Also, computing resources can be purchased from a “spot market” where the prices vary according to demand and other factors. Beyond computation, Amazon offers other services such as databases, load balancing, and DNS. The result is that the consumer of Amazon's cloud services has an overwhelming number of options.

Another key benefit of cloud computing is that user can easily change their cloud-based infrastructure. For example, Amazon sells computing resources by the hour. Consequently, the user is free to redesign their infrastructure every hour and incur minimal cost penalty. To put it another way, the user can navigate the overwhelming options provided by a CSP, and they can be navigated every hour.

Since the cloud computing paradigm is new, users have limited expertise in optimally utilizing the cloud services. For example, a user can save significant amounts of money by utilizing lower cost cloud computing services. However, the pricing of the services relates to the different performance features of the service. Therefore, the user must carefully balance their performance objectives with the cost of the cloud services. The situation is further complicating in that the performance features of the cloud services need not be the same as the performance objectives of the user. For example, a user might seek to implement a web server using the computational resources purchased from the CSP. The user's key performance metric might be the response time, which is the time between when the web server receives a request for a web page and the time the web server replies with the requested web page. However, the CSP's computational resources do not specify the response time as a performance metric. Instead, the CSP might specify the type of processor and the amount of available memory. Hence, selecting the cloud services that maximize the user's performance metrics can be a complicated task.

In the past, when an IT professional desired to deploy a web server, they would simply purchase a very large machine and house the machine in a datacenter. The performance of the web server would be monitored. If the performance were not suitable, then more computational resources would be purchased and added to the datacenter. Specifically, the goal of the IT professional was to keep the web server over-provisioned and over-provisioned by an amount large enough so that new resources need to be added infrequently, as datacenters typically charge for adding computational resources and the purchase of computational resources might require budget analysis by several managers. A key component of this process is the monitoring of the performance of the web server. As the detection of insufficient performance triggers the purchase of additional computing resources, as a result, performance monitoring is well established and supported by many products. However, performance monitoring alone does not help the users of cloud services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described embodiments provide for managing a cloud computing system of a user with cloud services provided by a plurality of cloud service providers. Cloud service data is collected from sensors within each cloud service of a corresponding cloud service provider. One or more system models are developed based on the collected cloud service data; and user configuration data is received for the cloud computing system, the configuration data related to performance and cost objectives of the user. Performance and cost predictions for the cloud computing system are generated based on the one or more system models and the user configuration data; and the performance and cost predictions are processed to provide a set of attributes and parameters for the cloud computing system. The set of attributes and parameters for the cloud computing system are presented to the user for selection, wherein, based on the set of attributes and parameters, the cloud computing system operates by employing selected attributes and parameters from within a set of differing cloud service providers.

### BRIEF DESCRIPTION OF THE DRAWING FIGS.

Other aspects, features, and advantages of described embodiments will become more fully apparent from the following detailed description, the appended claims, and the accompanying drawings in which like reference numerals identify similar or identical elements.

FIG. 1 shows a block diagram of a communications network that collects data regarding the function of cloud services in accordance with exemplary embodiments;

FIG. 2 shows a block diagram of an administrative server of the communications network of FIG. 1;

FIG. 3 shows a flow diagram of an exemplary cloud service prediction operation performed by the administrative server of FIG. 2;

FIG. 4 shows a flow diagram of an exemplary performance prediction operation of the cloud service prediction operation of FIG. 3;

FIG. 5a shows a flow diagram of an exemplary cost prediction operation of the cloud service prediction operation of FIG. 4;

FIG. 5b shows a flow diagram of an alternative exemplary cost prediction operation of the cloud service prediction operation of FIG. 4;

FIG. 6 shows an exemplary image of a dashboard summary screen of a cloud services management system in accordance with exemplary embodiments;

FIG. 7 shows an exemplary image of a summary screen for system health in accordance with exemplary embodiments;

FIG. 8 shows an exemplary image of a summary screen for service level target planning for a selected asset in accordance with exemplary embodiments;

FIG. 9 shows an exemplary image of a summary screen for node classification by pricing plan in accordance with exemplary embodiments;

FIG. 10 shows an exemplary image of a summary screen for multiple nodes/assets in accordance with exemplary embodiments;

FIG. 11 shows a flow diagram of an exemplary confidence value prediction operation in accordance with exemplary embodiments;

FIG. 12 shows a flow diagram of an exemplary mitigation operation in accordance with exemplary embodiments; and

FIG. 13 shows an exemplary block structure for selecting a target application time.

### DETAILED DESCRIPTION

Described embodiments provide for managing a cloud computing system of a user with cloud services provided by a plurality of cloud service providers. Cloud service data is collected from sensors within each cloud service of a corresponding cloud service provider. One or more system models are developed based on the collected cloud service data; and user configuration data is received for the cloud computing system, the configuration data related to performance and cost objectives of the user. Performance and cost predictions for the cloud computing system are generated based on the one or more system models and the user configuration data; and the performance and cost predictions are processed to provide a set of attributes and parameters for the cloud computing system. The set of attributes and parameters for the cloud computing system are presented to the user for selection, wherein, based on the set of attributes and parameters, the cloud computing system operates by employing selected attributes and parameters from within a set of differing cloud service providers.

Table 1 defines a list of acronyms employed throughout this specification as an aid to understanding the described embodiments:

TABLE 1

| | | | |
|---|---|---|---|
| API | Application Programming | CA | Confidence Alert |
| | Interface | | |
| CL | Confidence Level | CPU | Central Processing Unit |
| CSP | Cloud Service Provider | CV | Confidence Value |
| EA | Event Analyzer | IaaS | Infrastructure as a Service |
| I/O | Input/Output | IT | Information Technology |
| PaaS | Platform as a Service | SaaS | Software as a Service |
| TAT | Target Application Time | TPL | Target Performance Level |

FIG. 1 shows a block diagram of communications system 100 that collects data regarding the function of cloud services. Communications system 100 includes one or more cloud service providers, shown as cloud services 102(1)-102(n), each of which typically might include one or more servers, processors, data storage, and other information technology (IT) resources, shown generally as servers 108(1)-108(n). Cloud service providers 102 are in communication, via network 106, with system administrator 110 and one or more user devices, shown as 112 and 114. User devices 112 and 114 might be implemented as a desktop computer, a laptop computer, or a mobile device, such as a smartphone or tablet. For example, user device 112 might be any network-communications enabled computer operating (1) a LINUX® or UNIX® operating system, (2) a Windows XP®, Windows VISTA®, Windows 7® or Windows 8® operating system marketed by Microsoft Corporation of Redmond, Wash. or (3) an Apple operating system as marketed by Apple, Inc. of Cupertino, Calif. For example, user device 114 might be any mobile device, such as an IPAD® tablet computer or an IPHONE ® cellular telephone as marketed by Apple, Inc. of Cupertino, Calif., or any mobile device operating an ANDROID® operating system as marketed by Google, Inc. of Mountain View, Calif. or a Windows Mobile ® operating system as marketed by Microsoft Corporation of Redmond, Wash., or any other suitable computational system or electronic communications device capable of providing or enabling an online service.

Each of cloud services 102(1)-102(n) (e.g., servers 108(1)-108(n)) are separately addressable and each might include one or more monitoring sensors operable on one or more of servers 108(1)-108(n). Each sensor monitors a quantifiable quality of server 108 that relates to a performance aspect of the corresponding cloud service 102.

Network 106 might include wired and wireless communications systems, for example, a Local Area Network (LAN), a Wireless Local Area Network (WLAN), a Wide Area Network (WAN), a Personal Area Network (PAN), a Wireless Personal Area Network (WPAN), or a telephony network such as a cellular network or a circuit switched network. Thus, in exemplary embodiments, network 106 might be implemented over one or more of the following: LTE, WiMAX, UMTS, CDMA2000, GSM, cell relay (ATM), packet switched (X.25, Frame-Relay), Circuit switched (PPP, ISDN), IrDA, Wireless USB, Bluetooth, Z-Wave, Zigbee, Small Computer System Interface (“SCSI”), Serial Attached SCSI (“SAS”), Serial Advanced Technology Attachment (“SATA”), Universal Serial Bus (“USB”), an Ethernet link, an IEEE 802.11 link, an IEEE 802.15 link, an IEEE 802.16 link, a Peripheral Component Interconnect Express (“PCI-E”) link, a Serial Rapid I/O (“SRIO”) link, or any other similar interface link for communicating between devices.

FIG. 2 shows a block diagram of system administrative server 110. As shown in FIG. 2, system administrative server 110 includes one or more processors 202, one or more network interfaces 208, system memory 210 and input/output (I/O) interface 204, which are all in communication with one another via bus 206. I/O interface 204, for example, might accept input from, and provide output to, an operator of system administrative server 110, for example via a keyboard, mouse, monitor, printer and other peripheral devices. Network interfaces 208 are in communication with one more networks of network 106. Administrative server 110 might also include one or more sensors (shown as 212) to collect sensor data. Alternatively or additionally, each server 108 might also include one or more sensors. The sensor data and other information are collected from external Application Programming Interfaces (APIs) provided by one or more Cloud Service Providers (CSPs), a piece of software (agent) that runs on a physical server, an agent that runs on a virtual server, an agent that runs on a physical machine where the virtual machine is running, and/or an agent that on hardware that is external to the machine where the server is running, for example, a network device that records network traffic flowing to and from the server. Using these sensors, performance and cost of cloud usage data is collected and the data is sent to server for storage and computation. The frequency of the data collection might depend on the metric being observed. The sensors might monitor one or more cloud assets for performance, availability, resource usage cost, security, compliance, social and/or one or more additional aspects of performance or values of reliability. In some embodiments, the monitoring occurs in real-time.

In described embodiments, administrative server 110 might be implemented as a system that selects the cloud services and versions of services that achieve a desired target performance while minimizing the cost of the cloud services and access to the cloud services. The question of whether a particular set of cloud services meets the target performance is answered through predicting the value of the performance metrics on that set of cloud services. In general, both private and public cloud providers allow the cloud consumer to select between a wide range of different types of services and versions of a service (e.g., a faster version or a slower version, etc.).

“Cloud services” refers to a set of services offered by CSPs. These services include virtual machines usage, compute resources usage, disk IO usage, storage usage, network usage, database usage, DNS, load balancer usage, and data caching systems. The set of cloud services also includes different versions of specific services, such as specific versions of virtual machines. These versions can also include different levels of services. For example, a disk IO service can be purchased at different levels of service where a higher level of service supports higher data rate or better performance in terms of different performance metrics. The set of cloud services also includes the amount of usage of the services. Specifically, the set of cloud services for using a virtual machine is not just the use of a virtual machine, but the amount of time the virtual machine is used. Similarly, cloud services for using the network are not just the use of the network, but the amount of use, in terms of received and transmitted bytes and other network metrics. The set of cloud services also includes a range of purchasing options. For example, the CSP might offer the use of a virtual machine for purchase with a wide range of contracts including purchasing the use by the minute or purchasing the use for three years of continuous use. Also, these contracts might be bought and sold on a secondary market, or some other market. In summary, the term cloud services includes a large range of ways that the CSP offers the cloud consumer to purchase.

Administrative server 110 performs several functions to help the user select sets of cloud services and understand the relationship between cost and performance for one or a set of cloud-based systems. Administrative server 110 might be composed of several components and these components can run on one of more fixed or virtual machines. The administrative server provides outputs in terms of a graphical user interface that might be available to users via a web interface. The administrative server might also provide results via reports that are generated and distributed to users via email, download, or other means. Administrative server 110 also collects user configuration information. The user can adjust the configuration through a graphical interface. Also, the user can adjust the configuration and observe the results in an interactive way. Administrative server 110 can directly provide the graphical user interface, for example through a web-based interface, or can act as a portal where data is collected and results provided to a graphical and computational system that runs on a separate machine. Besides providing a way to interact with the user, administrative server 110 collects a wide range of information from a wide range of sources, and performs a wide range of computations with collected data and user inputs.

An example of how a user (also referred to herein as an administrator) interacts with administrative server 110 is as follows. The user logs into administrative server 110 to begin a session, and might enter various types of user information regarding preferences and expectations. However, this is not necessarily required, in which case predefined or pre-determined preferences are used. Next, the results of the predicted cost and performance can evaluated. Based on the results, the user might select whether to continue the session or end the session. If the session continues, the user again might enter various types of user information regarding preferences and expectations performed, the results of the predicted cost and performance can evaluated. By repeating this process iteratively, the user can evaluate the performance and cost of the cloud-based systems in a wide range of scenarios and under a range of performance and cost objectives.

FIG. 3 shows a flow diagram of an administrative server 110 from another perspective. At step 302, prediction algorithm 300 begins, for example at a startup of system 100, by the initiation of the user as a customer, and/or the start-up of the administrative server 110. Prediction algorithm 300 might also be performed, for example, periodically during operation of administrative server 110 or might continually operate in the background of operation of administrative server 110. At step 304, administrative server 110 initiates the collection of data from a range of sensors, described in more detail below. These sensors collect data from the user's systems, which may or may not be currently utilizing cloud services. Once step 304 is complete, data is periodically collected. Once sufficient data is gathered, at step 306, models of the user's system are developed. At step 308, user configuration data is collected, which data is related to performance objectives and cost objectives, which are discussed subsequently in more detail. At step 310, predictions of cost and performance of the user's cloud-based systems are generated. At step 312, analysis of these cost predictions is performed. At step 318, the predictions and analysis of the predictions are used to generate output that includes graphics, tables, and lists. At step 320, the user evaluates the results generated in step 318. The user can then adjust parameters and explore new predictions based on these parameter values, in which case, the process returns to step 308. Alternatively, the user might return at a later time once more data has been collected and, hence, new output has been generated, in which case the process advances to step 322, where the system operates according to the set of attributes. Note that several actions are performed asynchronously. For example, sensor data is continuously collected. Cost and performance predictions are generated as data is collected or once a sufficient amount of new data is collected. The output is generated both as new predictions and analysis of the predictions are complete and as user requests, for example, through use of the dashboard.

Thus, based on the dashboard output provided at step 318, described embodiments help a cloud services consumer design the cloud infrastructure for their cloud-based systems to meet desired performance and cost objectives. In general, a cloud consumer's cloud-based system seeks to deliver a service to its end-users. For example, if the cloud-based system is an ecommerce website, the system seeks to provide a website to allow and encourage visitors to make purchases on the website. In all cases, the cloud consumer's system seeks to provide its service with some type of quality where quality can be measured in terms of one of more performance metrics. For example, a cloud-based web site might seek to employ a cloud-based system that results in a short duration between the time when the end-users web request (e.g., an http request) reaches the web server and the time when the web server sends the web reply (e.g., the http reply). In this case, the metric is the http response time and the cloud consumer desires a low http response time.

A cloud-based system such as a web site might have multiple components, including a database, where the database could be a service that a cloud service provider offers or the database could be a program running on a virtual machine that the cloud service provider offers. The cloud consumer has many design options including whether to use a database provided by the cloud service provider or a database of the cloud consumer's choice running on a physical or virtual machine offered by the cloud service provider. Moreover, cloud service providers have a wide range of virtual machines from which to choose, and databases provided by the cloud service provider have several options. Also, the cloud consumer can configure the database in different ways. For example, the data could be spread over several different databases, in a technique known as data sharding. Data sharding generally reduces the amount of data stored in each database segment (or “shard”), which reduces the database index size and improves search performance. Further, each database shard can be placed on separate hardware enabling distribution of the database over multiple machines, which can also improve performance. Alternatively, employing a single database allows several machines to work together on the same database, so the cloud consumer can select the number of machines.

The disclosed system helps the cloud services consumer to select cloud services and therefore design their cloud-based systems. Specifically, the disclosed system predicts the performance (in terms of specific metrics) for different cloud services and computes the cost of these configurations. Described embodiments collect a wide range of data that is relevant to the performance, cost, and design options of the cloud consumer's cloud-based system and, based on the collected data, predicts the performance, in terms of specific metrics, of the cloud consumer's system for different set of cloud services and versions of services. Described embodiments also predict the cost of different types of cloud services and versions of services. Thus, described embodiments allow the cloud consumer to explore the relationship between cost and performance and utilize the cost and performance predictions to design the cloud-based system.

As shown at step 304 of FIG. 3, described embodiments of administrative server 110 employ sensors 212 to collect sensor data. Sensors collect data on performance, referred to as “performance metrics”. The sensors might directly monitor metrics or monitor a collection of metrics and then process the metrics in order to determine a new metrics, termed herein “indirect monitoring”. A wide range of metrics are monitored through direct or indirect monitoring. The sensors directly or indirectly monitor (a) “System metrics”; (b) “Application metrics”; (c) “Business metrics”; (d) “Usage metrics”; (e) “Cost metrics”; and (f) “Classes of services and versions of services” for various purposes herein.

System metrics include metrics such as CPU Utilization, Disk I/O, network bytes in, network bytes out, memory size and utilization, processes running and the amount of system resources consumed by each process, the processes running and the amount of time each process spends waiting to consume resources or waiting for operating system or some agent to complete a transaction so that the process can continue to run, and the fraction of file read or write request that are handled by memory without requiring a disk access. System metrics further include metrics such as the dynamics of memory usage such as how long data that is stored on disk is also cached data in memory, the number of processor memory requests that are require access to different processor caches and system memory, and other similar data.

Application metrics include metrics such as server response time (the time between when a client's request is received by the server to the time when the server response to the request). Examples of server response time include (i) the time from receipt of an http request to when the web server generates the web server response or completes the response, and (ii) the time from receipt of a database query to when the database application generates a response to the query. Other application metrics might include incomplete or unfinished server responses and computation completion time (e.g., the time to complete a computational task), and other similar data.

Business metrics include metrics such as number of transactions completed, revenue generated by a transaction, revenue per web page viewed, revenue generated by a web site visitor, the amount of time a user spends on the web site downloading or viewing one or more web pages, the amount of time a user spends using the interactive cloud-based application, the revenue generated by a user of a interactive cloud-based application, click-through rates, and other similar data.

Usage metrics include metrics such as how many hours the node or service is in use, the node or service start time, the node or service stop time, and other similar data.

Cost metrics include metrics such as the cost of using a cloud service, the cost of using a virtual machine, the cost of using a database, the cost of sending data over the network to a particular destination, the cost of receiving data over the network from a particular destination, the cost of using a type of storage, and the cost of using a cloud service such as a load balancer, preconfigured virtual machine, or DNS service. Other cost metrics include the cost of using different versions of a service such as a faster version, a more reliable version, a version located in different locations, a version that gives different performance, options, or tools, cost changes based on time of use or duration of use, and the like. The cost metrics, like any of the metrics, might vary over time. For example, the CSP or some other group might provide a secondary market where service contracts can be sold and/or purchased from other parties. In this case, the costs of services will vary according to the prices offered by buyers and sellers. Also, the cloud service provider might provide a spot market, where the prices of services varying according to current supply and demand and other factors chosen by the cloud service provider. The cost metrics can include actual money that a public cloud provider charges for the use of the services or the inferred or implied cost that a private cloud within an enterprise charges the business unit for using the service. More specifically, the cost observed does not necessarily imply that money transfers between distinct parties to use the service, but could also mean that there is some method to account for the usage of the cloud service. The cost information is collected from relevant sources including the costs advertised by a public cloud provider, costs advertised by a private cloud provider, costs advertised on a market, and costs advertised by a cloud service broker.

Classes of services and versions of services include specific information related to service class and service version offered by various private and public cloud providers to the cloud consumer.

In many cases, users are interested in future performance and cost under various scenarios. One component of a prediction of the future performance and cost is the “usage and demand” on the cloud-based system. For example, if the cloud-based system is a web server, then the number of web clients that utilize the web server affects the usage and demand on that cloud-based system. As another example, consider a computational cloud-based system that performs specific computations for customers. In this case, the number of customers affects the usage and demand. Usage and demand can follow trends as well as diurnal and seasonal patterns. The disclosed system allows the user to provide scenarios through a graphical user interface, where each scenario might have a different expected variation in usage and demand for the cloud-based systems under consideration. The disclosed system might also use the past usage and demand in order to extrapolate to future usage and demand. The disclosed system might also use past usage and demand of similar cloud or non-cloud based systems. For example, if the customer's is designing a ecommerce system for ecommerce of men's shoes, the seasonal patterns from other similar types of commerce can be used to estimate the usage and demand for the customer's ecommerce systems.

Costs of cloud services also vary over time. The disclosed embodiments compute predictions of the future cost of cloud services. For example, these predictions can be based on past trends in the cost of these services or information regarding CSPs plans. The disclosed system allows the user to select and construct scenarios for cloud services cost variations.

FIG. 4 shows additional detail of performance prediction step 310 of FIG. 3. At step 402, performance prediction step 310 starts. At step 404, administrative server 110 employs the detected sensor data to predict the system metrics, application metrics, business metrics, and/or usage metrics for different classes of cloud service and for different levels of usage of the cloud consumer's cloud-based system. This prediction is based on one or more computational models that relate system metrics and class and version of cloud service to system metrics, application metrics, business metrics, and usage metrics. The computational model used depends on the processes and applications running on the system. At step 406, administrative server 110 determines whether the processes, applications, and hardware assets of the system have been modeled based on sensor data. If, at step 406, the processes, applications, and hardware assets of the system were not modeled on sensor data, then, at step 408, administrative server 110 models the processes, applications, and hardware assets based on similar, previously modeled processes, applications, and hardware assets of the system. Process 310 then proceeds to step 410. If, at step 406, the processes, applications, and hardware assets of the system were modeled on sensor data, then at step 410, administrative server 110 generates performance predictions based on the modeled processes, applications, and hardware assets of the system. At step 412, process 310 completes.

For example, at step 408, consider the simple case where, through prior measurements, it is determined that program X is able to complete a job twice as fast on system of type A as compared to system of type B. If observations are made that (i) program X is being used and (ii) the job took two hours to run on system A, then the predictor predicts that the job will take four hours to run on system of type B. While this is one type of predictor, more accurate predictors use a wide range of metrics to make the prediction. Note that in the above case, a model for program X is utilized to make the prediction. In case that program Z is running, and models were developed only for programs X and Y, then the similarity between program Z and programs X and Y might be determined

For example, one way to compute similarity of programs is as follows. A program might generally utilize computational resources, read and write data to and from a hard drive and/or a memory, and send and receive data over a network. For a given amount of time spent in operation (e.g., a given unit of computing time), the program might: read and write data to the hard drive, and send and receive data over the network. A profile of a program might thus include four values: the average number of bytes written to the disk, the average number of bytes read from the disk, the average number of bytes sent over the network, and the average number of bytes received over the network for a given unit of computing time. The similarity of two programs might be determined as the average ratio of these values. The similarity of two programs X and Z is denoted as S(X, Z). Based on (i) the similarity values, (ii) the computation time of program X running on systems A and B, (iii) the computation time of program Y running on systems A and B, and (iv) the computation time for program Z to run on system A, administrative server 110 predicts the computation time for program Z to run on system B. For example, the predicted running time of program Z on system B might be determined based on relations (1) through (3):

(W(X)*R(X,B)/R(X,A)+W(Y)*R(Y,B)/R(Y,A))*R(Z,A) (1)

where

W(X)=S(X,Z)/(S(X,Z)+S(Y,Z)) (2)

and

W(Y)=1−W(X) (3)

and where R(X,A) is the running time of program X on system A, R(X,B) is the running time of program X on system B, and R(Y,A), R(Y,B), R(Z,A) are defined similarly.

Although, as described for the example above, only the computation time metric was considered to determine program similarity, described embodiments might generally consider one or more metrics to predict performance of similar programs. For example, although described above as a choice between a system of type A and B, in other cases, the selection is between a wide range of configurations, where a configuration might utilize many cloud services. By iterating or searching through different possible combinations of cloud services and versions of services, the system can predict the performance for relevant types and versions of cloud services.

Based on the past observations, administrative server 110 might predict the performance and cost of the cloud services and versions of services that might be employed by a cloud system in the future. An example of a cost predictor is a linear extrapolation of observed usage and the predicted costs of the extrapolated usage. More sophisticated predictors consider that the cost of some services vary according to diurnal or seasonal patterns. Also, the user input configuration data input at step (FIG. 3) might be examined and extrapolated to define the future usage. The cost prediction might account for several factors, including the predicted duration that virtual machines will run, the predicted number of virtual machines that will run, the predicted disk IO, the predicted network IO, and the predicted use of other cloud services such as load balancers, databases, and DNS services. Moreover, the cost prediction might also take into account that other types of cloud services might be required to meet the performance goals that the user seeks to maintain. For example, if usage and demand is predicted to increase, then not only will virtual machines need to be run for more hours, but a different type of virtual machine might be required, or perhaps a different class of service will be required. For example, the increase in usage might require faster disk IO, achieved by changing the number and types of disks used by each virtual machine. The cost prediction also might use predictions of different types of service markets. For example, some service markets might advertise a cost that is constant for extended periods of time and only changes when the cloud service provider or service broker announces a change in price. These costs tend to vary as technology advances make faster computing resources cheaper and because of competition between cloud service providers. A different predictor is required for cloud services available on markets where different cloud consumers buy and sell cloud services, or on markets where a broker or cloud service provider sells cloud services at a rate that depends on the demand or other factors.

Thus, administrative server 110 might generate cost predictions that are single predictions of the cost at some point in the future or a prediction of the distribution of the cost in the future, or some statistical function of the prediction of the distribution of the cost in the future. The distribution and statistical function are useful in predicting quantities such as the likelihood that the cost for a service will exceed a threshold value. The system provides not only the predicted cost to achieve a specific performance goal, but also, the risk that the cost can exceed specific values.

FIG. 5a shows additional detail of cost prediction step 312 of FIG. 3. At step 502, cost prediction process 312 starts. At step 504, administrative server 110 determines one or more combinations of programs and assets that meet the performance prediction generated at step 310. At step 506, administrative server determines estimated costs, for example by determining published price data or based on previously observed or computed costs, for the desired versions of programs and assets to meet the performance level. At step 508, if the determined cost is below a desired cost threshold, step 512 generates the cost prediction output for review by the user. At step 514, the process of step 312 completes. At step 508 if the determined cost is not below the desired cost threshold, then, at step 510, administrative server 110 selects a different combination of programs and assets that can meet the desired performance level and estimates the cost of that combination at step 506.

FIG. 5b shows an alternative to the cost prediction step 312 of FIG. 3. At step 551, the cost prediction process of step 312 starts. At step 552, administrative server 110 collects user selections for configuration data, such as the user's performance objectives and the user's expected usage growth. Optionally, at step 553, case performance objectives for usage and demand are predetermined or determined from published “best-practices” and, as described above, usage variation can be estimated without explicit prediction from the user. Step 554 determines the sets of programs, cloud services, versions of programs and cloud services, and the amount of cloud services needed to meet the user's performance objectives under the predicted usage or demand determined in step 553. Note that multiple sets of services might meet the user's objectives. Step 554 determines one or more sets of services that meet performance objectives. At step 555, costs associated with each of the set of services are predicted. Moreover, if the services can be purchased with different types of contracts and different rate plans (e.g., upfront payment or pay-as-you-go), then multiple costs for each set of suitable cloud services is determined At step 556, the sets of services and costs might be reduced to a smaller set. This reduction to a smaller set might be driven by the determination that one set of services is cheaper than another set. This reduction might also take into account the user's desired selected payment strategies, such as the desired fraction of spending that should be spent upfront versus the fraction of spending that should be paid over time. At step 557, the results, such as the values of performance metrics and cost metrics are presented to the user through a graphical user interface or through a prepare report. At step 558, the process of step 312 completes.

The key difference between the approach shown in FIG. 5a and the approach in FIG. 5b is that the approach shown in FIG. 5a is driven by cost objectives and the approach in FIG. 5b is driven by performance objectives.

Once the predicted cost and performance metrics for different cloud services and versions of services is computed based on the approach in FIG. 5 or FIG. 5b, administrative server 110 allows the user to explore the relationship between performance and cost. For example, the user might specify “performance objectives”. These performance objectives might take the form of a target value of one or more performance metrics, where the user desires that each metric is allowed to either exceed or not exceed its target value. Another alternative is that the performance objectives include a range of values, where each metric of concern should above a minimum value and below a maximum value. The performance objectives might also include a quantitative or qualitative ranking of metrics in terms of the importance of each metric.

The disclosed embodiments might allow the user to design performance objectives through a graphical user interface. The performance objectives might be automatically designed according to industry best-practices. The industry best-practices can be determined from published reports, gathered from public data sets, or by actively probing systems and gathering performance information. In each case, the best-practices can be grouped according to business domains, and the user might be able to select the performance objectives indirectly by selecting business domain.

Along with performance objectives, the user might specify “cost objectives” as well as “cost models”. Cost objectives includes goals on spending a specific fraction of the total upfront as compared to paying incrementally over time. Cost objectives also include upper and lower limits on the total spending. Cost objectives might also be specified for specific components of cloud-based systems. In the case that the user is concerned with multiple cloud-based systems, cost objectives can be set for each cloud-based system. Cost models include translating spending to capital cost, present value, and other method that modify the predicted future spending. In all cases, “cost” means the value determined by a cost model.

Administrative server 110 then automatically selects the set of cloud services that meet the selected performance objectives and cost objectives. Alternatively, or additionally, the user might specify the cost objectives and administrative server 110 might then automatically select the cloud services that optimize maximize performance metrics according to rules specified as part of the performance objectives. As described above, performance objectives might include a ranking of importance of multiple performance metrics as well as ranges for various performance metrics.

Beyond predicting the set of cloud services that meet performance and cost objectives, administrative server 110 predicts the performances and costs of many sets of cloud services. This information allows the user to understand the relationship between performance and cost as well as select a set of cloud services that does not necessarily optimize performance or cost. For example, the administrative server 110 might also predict the cost and performance of when the usage and demand is higher and lower than the expected usage and demand, where, as mentioned, the expected usage and demand is (i) specified by the user or (ii) predicted from past usage and demand. This information helps the user understand the sensitivity, in terms of cost and performance, of different sets of cloud services.

Thus, as described herein, Target Performance Level (TPL) is selected by the user, is determined from published best-practices, or is based on industry norms. This TPL might be a single metric or a set of metrics. TPLs can be a system metric, application metric, business metric, custom metric or a combination of all, as described above. Furthermore, a user is allowed to select customer metrics the user can define using the configuration through a Cloudamize dashboard. Selection of TPL is applied to either a single node or a group of nodes (asset). A Performance Prediction and a Cost Prediction are generated the prediction of performance and cost of different sizes, types and plans. The user input on the TPL is saved and the performance of different sizes and types of systems and cloud services is predicted such that the minimum cost to achieve desired performance can be incurred. Administrative server 110 determines the system configuration that will meet the user's TPL at a minimal cost from all possible choices available. The recommendation of the cloud configuration is made available to the user on the Cloudamize dashboard. The cloud configuration recommendations are available for an individual node or an asset that meets that selected TPL.

The user can change TPL on the Cloudamize dashboard and get cloud configuration recommendation that meets the selected TPL for a node and/or for an asset through an iteractive user interface. Specifically, the Cloudamize dashboard provides methods of accepting user input and visuals of predicted performance and/or cost of the recommended or selected Cloud configuration as well as the current configuration. This level of optimization is achievable for a single node and a group of nodes.

FIGS. 6-10 show exemplary images of various dashboard views for presenting data to the user. For example, FIG. 6 shows an exemplary dashboard image 600 as rendered on a video display of the administration server 110. Dashboard image 600 is a user interface that enables a user to view a plurality of cloud service performance and cost predictions, confidence and health indicators, and other similar data regarding the status of the cloud system. FIG. 7 shows an exemplary “health” dashboard image 700 as rendered on a video display of the administration server 110. FIG. 8 shows an exemplary “asset optimization” dashboard image 800 as rendered on a video display of the administration server 110. FIG. 9 shows an exemplary “cost computation” dashboard image 900 as rendered on a video display of the administration server 110. FIG. 10 shows an exemplary individual node dashboard image 1000 as rendered on a video display of the administration server 110. For example, a confidence parameter may be associated with a specific cloud service and indicate current and/or historical data related to the performance of a selected cloud service (e.g., the confidence level that the cloud service is performing at its desired level). For example, each sensor in the system might provide data to administrative server 110 such that a confidence value (CV) can be derived for each cloud service.

FIG. 11 shows a flow diagram of process 1100 employed by administrative server 110 to generate Confidence Values (CVs) for various cloud services and assets based on data from the sensors 212. Process 1100 starts at step 1102. At step 1104, administrative server 110 determines if a new sensor message including new sensor data has been received by the administrative server. If no new sensor message has been received, process 1100 proceeds to step 1114. If, at step 1104, new sensor data has been received, then at step 1106, administrative server 110 generates an updated confidence value (CV) of the network asset(s) to which the new sensor data corresponds. At step 1108, administrative server 110 determines whether the updated confidence value calculated at step 1106 exceeds a threshold confidence level alert level value. If, at step 1106, the confidence value exceeds the confidence level alert level threshold, process 1100 proceeds to step 1112. If, at step 1106, the confidence value does not exceed the confidence level alert level threshold, administrative server 110 generates an alert message at step 1110. The alert message might typically include generating an alert message on the dashboard display, or notifying a designated user, for example, by email, automated call, text message, or a combination thereof At step 1112, the dashboard indicators are updated to display the updated confidence level(s) and sensor data. For example, alert rules and prescribed alerts on the dashboard display might include the following: CPU Utilization<20%=>Confidence level=green; CPU Utilization>=20% & CPU Utilization<40%=>Confidence level=blue; CPU Utilization>=40% & CPU Utilization<60%=>Confidence level=yellow; CPU Utilization>=60% & CPU Utilization<80%=>Confidence level=orange; and CPU Utilization>=80%=>Confidence level=red. At step 1114, process 1100 completes.

FIG. 12 is a flowchart of a confidence value mitigation process that might optionally be part of dashboard confidence alert generation step 1110 of FIG. 11. At step 1202, process 1110 starts. At step 1204, administrative server determines one or more potential mitigation actions that could restore the confidence value above the desired threshold. At step 1206, administrative server 110 generates a mitigation advisory to the user. The mitigation advisory message might typically include generating an alert message on the dashboard display, or notifying a designated user, for example, by email, automated call, text message, or a combination thereof, such that the user can decide which, if any, mitigation option to select and implement. At step 1208, administrative server 110 determines whether the user selected one of the mitigation options. If so, at step 1210, administrative server 110 applies the selected mitigation settings to the setup of the cloud system. Process 1110 proceeds to step 1212. If, at step 1208, the user did not select a mitigation option, then, at step 1212, the dashboard indicators are updated based on current data. For example, the confidence measurements might be normalized and processed by administrative server 110 to determine whether any dashboard confidence value needs to be updated. At step 1214, process 1110 completes.

In described embodiments, the confidence values might be based on data such as, but not limited to, aspects of computational performance of one or more cloud assets, such as CPU Utilization, disk reads, disk writes, memory usage, system down events, network bytes in, and network bytes out. Additionally, the confidence values might be based on data security qualities of one or more cloud assets, such as instances of system unavailability, SQL injection attack detection, XSS scripting attack detections, instances of unauthorized login attempts, file integrity checksum change detections, instances of ports being open to public Internet Protocol addresses, security policy compliance and other security data. The confidence values might also be based on cost related measurements, e.g., per hour billings, daily billings, and monthly billings. Finally, social values, such as detected levels of credibility, reputation, reports of unexpected high costs, and dissatisfied user indications might also be considered.

FIG. 13 shows a flowchart of operation of the administrative server 110 in generating and rendering a confidence value. At step 1302, process 1300 starts. At step 1304 administrative server 110 selects a system asset for which to generate a confidence value. At step 1306, administrative server 110 retrieves current sensor data from one or more sensors corresponding to the selected system asset. At step 1308, administrative server 110 retrieves historical data, for example historical sensor data and/or historical confidence values, for the selected system asset. At step 1310, administrative server 110 selects a formula by which to determine the confidence value for the selected system asset. At step 1312, administrative server 110 generates the confidence value for the selected system asset based on the selected formula and the current and historical data. At step 1314, administrative server updates the dashboard display with the generated confidence values. At step 1316, process 1300 completes.

An example calculation of the updated confidence value CV for the selected system asset might employ relation (4), as follows:

CI=(HV1+AV1+A1(CM1)+A2(CM2)+B1(ECM1)+B2(ECM2))/OV, (4)

where A1, A2, B1, and B2 are coefficients and a denominator measurement is a maximum possible measurement of the summed numerator of the equation. Alternatively, the confidence value might be determined by relations (5)-(7):

CS_{CO}=Performance=max[P(ca)IM(ca), Past CS_{CO}] (5)

CS_{Metric}=Health=max(max_{performance & reliability}, (S*CS_{CO}), Past CS_{Metric}) (6)

CS_{Overall}=max(max_{all metrics}(S*CS_{Metric}), Past CSₒᵥₑᵣₐₗₗ) (7)

where CS=Confidence Score, CO=Confidence Objective, CA=confidence alert, P(ca)=probability of a confidence alert, IM(ca)=impact matrix of this confidence alert, and S is a scaling factor that can be chosen to weight impact on the overall Confidence, where 0<S<=1.

Thus, as described herein, systems presently available generally do not predict performance and cost of cloud-based systems that utilize different cloud services, although some products exist that allow user to run the workload on different types and sizes of machines and benchmark. However, described embodiments allow users to predict the performance and cost without actually running the workload, but instead by selecting the set of cloud services that the cloud-based systems should utilize from a drop-down menu and seeing how the cloud services impacts the future cost and performance of cloud-based systems.

Reference herein to “one embodiment” or “an embodiment” means that a particular feature, structure, or characteristic described in connection with the embodiment can be included in at least one embodiment. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

While the exemplary embodiments have been described with respect to processing blocks in a software program, including possible implementation as a digital signal processor, micro-controller, or general-purpose computer, described embodiments are not so limited. As would be apparent to one skilled in the art, various functions of software might also be implemented as processes of circuits. Such circuits might be employed in, for example, a single integrated circuit, a multi-chip module, a single card, or a multi-card circuit pack.

Described embodiments might also be embodied in the form of methods and apparatuses for practicing those methods. Described embodiments might also be embodied in the form of program code embodied in non-transitory tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing described embodiments. Described embodiments might can also be embodied in the form of program code, for example, whether stored in a non-transitory machine-readable storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the described embodiments. When implemented on a general-purpose processor, the program code segments combine with the processor to provide a unique device that operates analogously to specific logic circuits. Described embodiments might also be embodied in the form of a bitstream or other sequence of signal values electrically or optically transmitted through a medium, stored magnetic-field variations in a magnetic recording medium, etc., generated using a method and/or an apparatus of the described embodiments.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various described embodiments.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard. Unless explicitly stated otherwise, each numerical value and range should be interpreted as being approximate as if the word “about” or “approximately” preceded the value of the value or range.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports might be referred to by the same name and are interchangeable for purposes here.

It will be further understood that various changes in the details, materials, and arrangements of the parts that have been described and illustrated in order to explain the nature of the described embodiments might be made by those skilled in the art without departing from the scope expressed in the following claims.

We claim:

1. A method of managing and designing a cloud computing system of a user with cloud services provided by a plurality of cloud service providers, the method comprising:
collecting cloud service data from sensors within each cloud service of a corresponding cloud service provider, or collecting data from sensors within a non-cloud datacenter;
developing one or more system models based on the collected data;
receiving user configuration data for the cloud computing system, the configuration data related to performance and cost objectives of the user;
generating performance and cost predictions for the cloud computing system based on the one or more system models and the user configuration data;
processing the performance and cost predictions to provide a set of attributes and parameters for the cloud computing system; and
presenting the set of attributes and parameters for the cloud computing system to the user for selection,
wherein, based on the set of attributes and parameters, the cloud computing system operates by employing selected attributes and parameters from within a set of differing cloud service providers.

2. The method according to claim 1, comprising:
receiving adjusted user configuration data for the cloud computing system, the configuration data related to performance and cost objectives of the user;
updating i) the performance and cost predictions for the cloud computing system and ii) the performance and cost predictions to provide an updated set of attributes and parameters;
presenting the updated set of attributes and parameters for the cloud computing system to the user for selection.

3. The method according to claim 2, wherein the adjusted user configuration data for the cloud computing system includes future variations in usage and demand of the cloud services provided by a plurality of cloud service providers.

4. The method according to claim 2, wherein the adjusted user configuration data for the cloud computing system includes future variations in usage and demand of the cloud services provided by a plurality of cloud service providers, the method comprising extrapolating current usage and demand of the cloud services.

5. The method according to claim 2, wherein the generating the performance and cost predictions for the cloud computing system based on the one or more system models and the user configuration data includes generating an expected usage and demand, and accounting for variations in the usage and the demand.

6. The method according to claim 2, wherein, for the generating the performance and cost predictions for the cloud computing system, the processing of the performance and cost predictions provides the set of attributes and parameters for the cloud computing system meeting the performance and cost objectives of the user.

7. The method according to claim 2, wherein, for the generating the performance and cost predictions for the cloud computing system, the performance predictions are based on business metrics.

8. The method according to claim 7, wherein the business metrics include http response time.

9. The method according to claim 1, wherein:
repeating the developing, the receiving, the generating, the processing and the presenting; and
the presenting further comprises providing a comparison of the performance and cost predictions in each repetition.

10. The method according to claim 9, comprising selecting, by the user, the set of attributes and parameters for the cloud computing system based on the comparison.

11. The method according to claim 9, comprising selecting, by the user, the set of attributes and parameters for the cloud computing system based on the comparison, wherein the comparison is of predicted revenue and cost.

12. The method according to claim 9, comprising selecting, by the user, the set of attributes and parameters for the cloud computing system based on the comparison, wherein the comparison is of configurations illustrating trade-off in operating performance and operating cost of the cloud computing system when in operation with the selected attributes and parameters from within a set of differing cloud service providers.

13. The method according to claim 1, wherein, for the collecting cloud service data from the sensors:
receiving the non-cloud service data from a datacenter, the cloud service data representing simulated cloud service operating attributes and parameters.

14. The method according to claim 1, wherein, the presenting the set of attributes and parameters for the cloud computing system to the user presents via a graphic interface.

15. The method according to claim 14, comprising:
receiving, via the graphic interface, adjusted user configuration data for the cloud computing system, the configuration data related to performance and cost objectives of the user;
updating i) the performance and cost predictions for the cloud computing system and ii) the performance and cost predictions to provide an updated set of attributes and parameters;
presenting the updated set of attributes and parameters for the cloud computing system to the user for selection via the graphic interface.

16. The method according to claim 1, comprising the step of monitoring whether the cloud computing system, when operating, meets the performance and cost objectives of the user.

17. The method according to claim 16, comprising alerting the user if the cloud computing system, when operating, does not meet the performance and cost objectives of the user.

18. The method according to claim 16, comprising:
monitoring whether the cloud computing system can operate with less cost than in a current operation and meet the performance and cost objectives of the user ; and
if so, altering components, and the selected attributes and parameters from within a set of differing cloud service providers, to operate the cloud computing system with less cost.

19. A non-transitory machine-readable storage medium, having encoded thereon program code, wherein, when the program code is executed by a machine, the machine implements a method of managing a cloud computing system of a user with cloud services provided by a plurality of cloud service providers the method comprising:
collecting cloud service data from sensors within each cloud service by a corresponding cloud service provider;
developing one or more system models based on the collected cloud service data;
receiving user configuration data for the cloud computing system, the configuration data related to performance and cost objectives of the user;
generating performance and cost predictions for the cloud computing system based on the one or more system models and the user configuration data;
processing the performance and cost predictions to provide a set of attributes and parameters for the cloud computing system; and
presenting the set of attributes and parameters for the cloud computing system to the user for selection,
wherein, based on the set of attributes and parameters, the cloud computing system operates by employing selected attributes and parameters within a set of differing cloud service providers.

20. A prediction system for modeling the performance of a network-based computing system, the network-based computing system comprising one or more network nodes and receiving cloud services provided by a plurality of cloud service providers, the prediction system comprising:
a processor coupled to a network comprising the one or more network nodes and adapted to receive configuration data from a user for the cloud computing system, the configuration data related to performance and cost objectives of the user, through an input/output (I/O) interface; and
one or more sensors configured to collect cloud service data from each cloud service of a corresponding cloud service provider,
wherein the processor is configured to:
(i) develop one or more system models based on the collected cloud service data,
(ii) generate performance and cost predictions for the cloud computing system based on the one or more system models and the user configuration data,
(iii) process the performance and cost predictions to provide a set of attributes and parameters for the cloud computing system, and
(iv) present the set of attributes and parameters for the cloud computing system to the user for selection, and
wherein, based on the set of attributes and parameters, the network-based computing system operates with selected attributes and parameters within a set of differing cloud service providers.
